(19) United States
(12) Patent Application Publication
(10) Pub. No.: US 2006/0095955 A1
(43) Pub. Date: May 4, 2006

(54) Jurisdiction-wide anti-phishing network service

(76) Inventor: Jeffrey Chiok Va Vong, Hong Kong (HK)

Correspondence Address: RAYMOND Y. CHAN, 108 N. YNEZ AVE., SUITE 128, MONTEREY PARK, CA, 91754, US

(21) Appl. No.: 10/979,524

(22) Filed: Nov. 1, 2004

(51) Int. Cl. H04L 9/32

(52) U.S. Cl. 726/3

(57) ABSTRACT

An anti-phishing method includes the steps of establishing an information center having a blacklist database, wherein the information center is liaising with at least an Internet service provider (ISP) through a communication network; collecting a plurality of phishing sources to be stored in the blacklist database to form a plurality of blacklist items therein; and sending the blacklist sources to the Internet service provider such that when a user of the Internet service provider tries to access a website source which matches with one of the blacklist items, the user receives a warning signal to inform the user that the website address is the phishing source.

### BACKGROUND OF THE PRESENT INVENTION

1. Field of Invention

The present invention relates to network security, and more particularly to an anti-phishing method which alerts a user when he/she is trying to enter into phishing websites so as to prevent stealing of the user's personal or financial information. Moreover, the present invention also stops phishing emails at the relevant phishing source so as to prevent the phishing originator from deceiving users via those phishing emails.

2. Description of Related Arts

With the advance of information technology, the suitability of which business transactions can be taken place on the internet has been substantially increased. People and enterprises prefer internet transactions because they may perform a wide range of business transactions online without actually going to the business organizations in question. This feature has become extremely important for those who are busy with their daily work and thus unable to spend much time for, say, traveling and lining up to perform a transaction. Moreover, online transaction is important for enterprises because of its reduced costs of dealing with customers and with its extended penetration of different markets.

One form of online business transaction which involves much sensitive information is internet banking. In recent years, almost all well-established banks have developed internet banking service in which their customers may access to a predetermined website and perform some particular kinds of banking transactions, such as money transfer or checking account balance.

Moreover, there exist several other forms of online transactions involving utilization of financial information that enables the user to access to banking and credit accounts. In such cases, the online merchants in question may receive confidential financial information that authorizes transfer of funds from banking and credit accounts to the relevant merchants account for the purpose of completing a particular online business transaction.

As one may appreciate, because many online transactions require exchange of important and sensitive information, the whole process should be kept strictly confidential and protected from unauthorized access. Conventional strategies for the protection of the information of online customers include data encryption during information transmission, passwords access to specific websites which show transaction information, hardened password techniques that include two factor authentication, and various kinds of security warnings which aim to increase the awareness of the online customers about insecure display of confidential information.

While these strategies are generally useful, there is one area in which the above mentioned strategies do not apply: prevention of fraud sites. As a matter of fact, there exist unauthorized persons who develop specific websites (fake websites) which imitate well-established online business websites and require sensitive information from those who have entered the fake websites. Thus, those who have been deceived would easily pass important information such as their credit card numbers or check numbers to the fake websites and the unauthorized persons may then collect the information and use it for illegal purposes.

In order to attract others to enter their fake websites, in some circumstances, the unauthorized person may actively send emails which direct the recipients to their fake websites so as to illegally collect confidential information from the recipients. Very often, these fake websites are so similar to the genuine business websites that ordinary members of the public and enterprises can hardly discover that they are in fact faked.

Thus one can observe that no matter how secure those well-established businesses protect their online customer's information, there is no way to prevent specifically-designed imitating sites from deceiving their customers so as to illegally acquire their personal or financial information. Therefore, it is easy to imagine that as time goes by, people and business enterprises would lose confidence in internet transactions and go back to conventional modes of business activities. This not only affects the business of individual companies, but also curtails the growth of information technology as a whole since there is simply no incentive for business enterprises to improve online business methods and technologies. Eventually, the ultimate losers are of course ordinary members of the public and business enterprises.

### SUMMARY OF THE PRESENT INVENTION

A main object of the present invention is to provide an anti-phishing method which alerts a user when he/she is trying to enter into phishing websites so as to prevent stealing of the user's personal or financial information by the phishing websites.

Another object of the present invention is to provide an anti-phishing method which is capable of blocking phishing emails from being received by users so as to prevent users from being deceived to access phishing websites.

Another object of the present invention is to provide an anti-phishing method involving an information center which is established for collecting a plurality of phishing websites sources (such as the relevant URLs) or phishing email servers to develop blacklists which are deployed in collaboration with ISPs and other mail server administrators in the same jurisdiction. The ISPs will take instruction from the phishing website blacklist and block the relevant phishing websites, wherein the user is warned against the blacklisted websites in a real time basis when he/she is entering to one of the phishing websites recorded in the blacklist. In other words, the user can still be warned even if his/her computer is infected by virus or spywares. The ISP's mail servers and other mail servers in the same jurisdiction will also receive instructions from the phishing mail blacklist and block phishing mails to prevent users receiving them and being deceived by the phishing emails.

Another object of the present invention is to provide an anti-phishing method which is adapted to launch in co-operation with Internet Service Providers (ISPs) such that blacklisted phishing websites are warned against a maximum number of internet users so as to combat any fraudulent conduct in relation to those phishing websites for minimizing damages to the public and business enterprises at large.

Another object of the present invention is to provide an anti-phishing method which is adapted to use for protecting e-banking and other online transactions users from being deceived or misrepresented by phishing websites to provide personal or financial information to the holders of those phishing websites.

Another object of the present invention is to provide an anti-phishing method which is easy to use and economical to implement, wherein the phishing websites database and the phishing mail database are regularly updated to cater for any latest establishment of phishing websites and phishing events. Specifically, there is no need to install any software to the user's computer so as to minimize the cost of running the anti-phishing method of the present invention and ensuring jurisdictional-wide and real-time update.

Accordingly, in order to accomplish the above objects, the present invention provides an anti-phishing method, comprising the steps of:
(a) establishing an information center having a blacklist database containing at least a phishing email blacklist and a phishing website blacklist, wherein the information center is liaising with at least one Internet service provider (ISP) through a communication network, such as Internet;
(b) collecting a plurality of phishing sources to be stored in the blacklist database to form a plurality of blacklist items selectively in the phishing email blacklist and the phishing website blacklist; and
(c) sending the blacklist items to the Internet service provider such that when a user of the Internet service provider tries to access a website source which matches with one of the blacklist items, the user receives a warning signal to inform the user that the website source is the phishing source.

These and other objectives, features, and advantages of the present invention will become apparent from the following detailed description, the accompanying drawings, and the appended claims.

### BRIEF DESCRIPTION OF THE DRAWINGS

FIG. 1 is a schematic diagram of the top-level architecture of an anti-phishing method according to a preferred embodiment of the present invention.

FIG. 2 is a schematic diagram of the data sources collection process and evidence establishment of the anti-phishing method according to the above preferred embodiment of the present invention.

FIG. 3 is a schematic diagram of the inspection and confirmation process of the anti-phishing method according to the above preferred embodiment of the present invention.

FIG. 4 is a schematic diagram of the output generation process of the blacklists databases of the information center according to the above preferred embodiment of the present invention.

### DETAILED DESCRIPTION OF THE PREFERRED EMBODIMENT

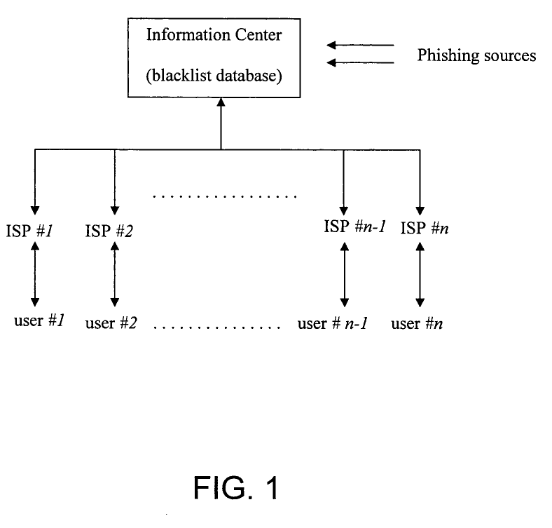

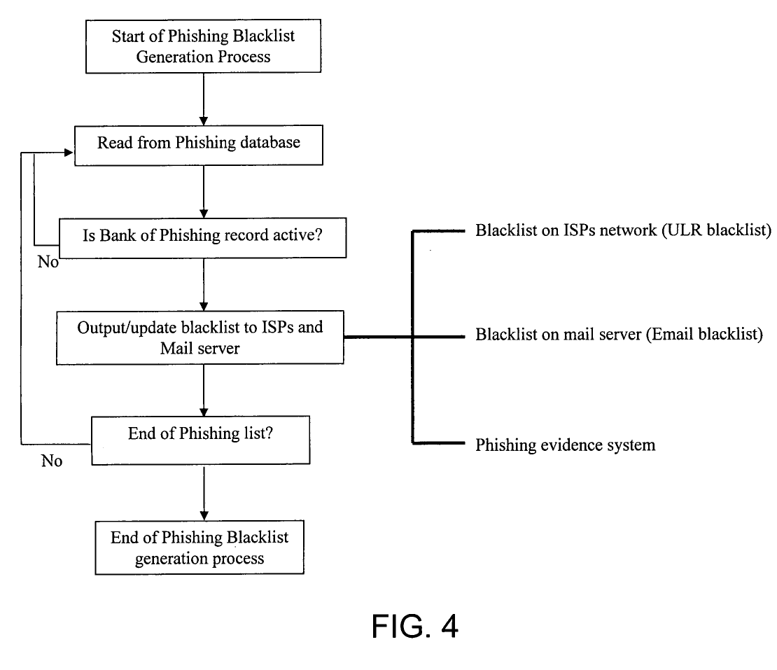

Referring to FIG. 1 and FIG. 4 of the drawings, an anti-phishing method for warning against possible phishing websites and for preventing phishing emails from reaching users according to a preferred embodiment of the present invention is illustrated, wherein the anti-phishing method comprises the steps of:
(a) establishing an information center having a blacklist database comprising at least a phishing email blacklist and a phishing website blacklist, wherein the information center is liaising with at least one Internet service provider (ISP) through a communication network;
(b) collecting a plurality of phishing sources to be stored in the blacklist database to form a plurality of blacklist items selectively in the phishing email blacklist and the phishing website blacklist; and
(c) sending the blacklist items to the Internet service provider such that when a user of the Internet service provider tries to access a website source which matches with one of the blacklist items, the user receives a warning signal to inform the user that the website source is the phishing source.

In step (a) above, the information center is established to launch the phishing website blacklist and the phishing email blacklist which stores a plurality of phishing items for warning against the users and for preventing phishing emails being received by the users. The phishing items may be of a predetermined category, so that the anti-phishing method is specifically designed to be applied in particular fields. For instances, according to the preferred embodiment of the present invention, the anti-phishing method is aimed to protect e-banking and other online transaction users from being deceived or misrepresented by phishing websites or emails which imitate e-banking or other online merchant services or request information on behalf of the banks or other online merchants.

In step (b) above, the phishing sources are collected to form the blacklists in the blacklist database wherein the blacklists are regularly updated to contain the most up-to-date information about the phishing websites and/or the phishing emails (the phishing sources).

In step (b), the method of the present invention further comprises the steps of:

(b.1) monitoring at least one data source to search for possible phishing sources having respective phishing identifications;
(b.2) preliminarily analyzing the possible phishing sources in the data source to identify the possible phishing source(s) as suspected phishing source(s) having the respective phishing identification(s); and

(b.3) verifying the suspected phishing sources selected in step (b.2), and storing the relevant phishing identifications as the blacklist items into the blacklist database when the suspected phishing sources are confirmed as phishing sources having the respective phishing identifications.

In order to distinguish the phishing sources, step (b.3) comprises the sub-steps of:

(b.3.1′) storing the phishing sources having the respective phishing identifications to phishing website database when the phishing source is a phishing website; and

(b.3.2′) storing the phishing sources having the respective phishing identifications to phishing email database when the phishing source is a phishing email.

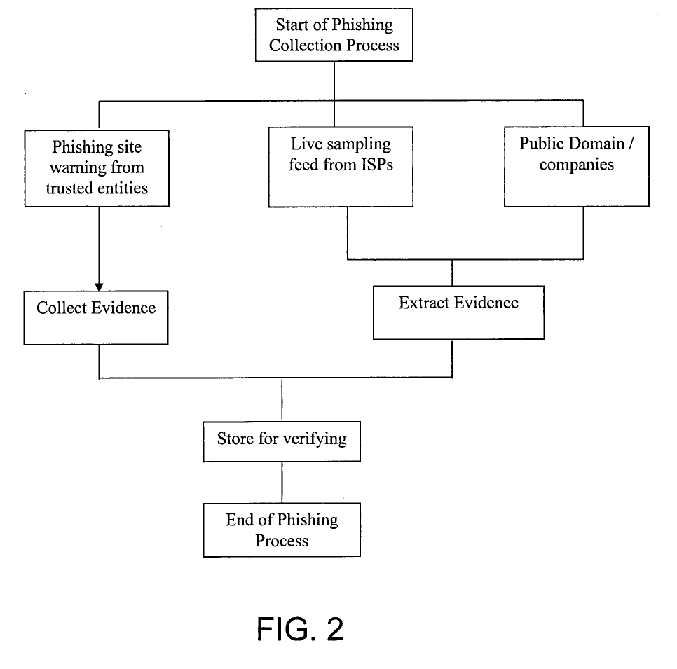

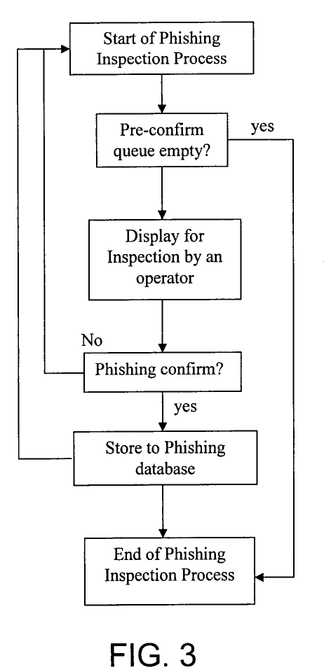

Referring to FIG. 2 and FIG. 3 of the drawings, according to the preferred embodiment of the present invention, there are three major data sources for use in collecting phishing websites as stated in step (b.1) above. These are: (i) emails circulating on internet; (ii) internet user reporting on any phishing websites; and (iii) trusted or associated websites reporting on any phishing websites. Thus, step (b.1) comprises the steps of:

(b.1.1) sampling junk emails which are circulated on the internet; and

(b.1.2) receiving emails which are forwarded by interested parties, including users of the present invention, and are said to be associated with phishing websites.

In relation to the second data source, the step (b.1) comprises the step (b.1.3) of receiving user reports on the internet of any phishing sources having the respective phishing identifications. According to the preferred embodiment, the phishing sources can broadly be divided into two categories, one being phishing emails having the phishing identifications embodied as the respective phishing emails server's IP address, and the other category being phishing websites having the phishing identifications embodied as the respective URLs of the phishing websites.

The phishing sources may be reported on a specifically designated webpage established by the information center, alternatively, it may be in the form of emails specifically sent to the information center for informing it of any phishing websites, URLs from search engines, and possible virus detection etc.

In step (b.2), the method of the present invention further comprises the steps of:

(b.2.1) passing the reported phishing sources into a phishing analysis module; and

(b.2.2) screening the reported phishing sources for generating a list of suspected phishing websites.

In the step (b.2) above, the reported phishing sources are passed to a phishing analysis module for screening suspected phishing sources. The suspected phishing sources would be lined up for in-depth inspection by an operator of the information center.

The list of suspected phishing sources would then be verified in accordance with step (b.3) so as to produce the blacklist addresses for storing into the blacklist database.

In step (b.3), the method of the present invention further comprises the steps of:

(b.3.1) checking the suspected phishing sources one by one by an operator preferably of the information center for confirming whether those suspected websites are indeed phishing websites;

(b.3.2) storing the suspected phishing sources' identifications as blacklist identifications when the operator so confirms.

In step (b.3.1) above, the operator would first check the IP address of the emails sending server first, and if this is not possible, the operator will actually inspect the content of the emails which report the phishing website and take the appropriate actions, such as actually checking the relevant suspected phishing websites. In some circumstances, the operator may verify with the bank or online merchant concerned so as to identify the genuineness or otherwise of the suspected phishing websites.

According to the preferred embodiment of the present invention, the step (b) further comprises a step (b.4) of saving phishing evidence into an evidence database of the information center. The phishing evidence may be the junk emails themselves, the phishing reporting emails or the reports sent by the trusted or the associated websites. This phishing evidence stored in the evidence database may be utilized to demonstrate the validity of subsequent blocking or intercepting actions.

In step (c) above, the warning signal is embodied as a warning webpage specifically linked to the information center or the relevant internet service provider (ISP) for allowing the user to choose whether he/she really wants to access to the phishing source (such as a phishing website), or to avoid entering the phishing source. The latter may involve redirecting to a predetermined website so as to prevent the user from entering into the phishing source (the phishing website).

An alternative warning is a specifically designed pop-up dialogue box which temporarily freezes access to phishing websites or emails until a response from the user is entered. At this point, again, the user may choose to nevertheless access to the phishing website, or to be redirected at another specifically designed security webpage launched by the information center or even the relevant ISPs.

As a result, the ISP in step (a) and step (c) are anti-phishing service deployment partners, so that users are warned against phishing websites and/or emails. Alternatively, the ISP and other email servers in step (a) and step (c) can be email service providers so that users are prevented from receiving phishing emails.

To summarize, step (c) of the anti-phishing method further comprises the sub-steps of:

(c.1) warning the user that they are about to enter a phishing website and prompting the user to choose between stopping entry and nevertheless accessing to the phishing source;

(c.2) allowing the user to access to the phishing source when the user chooses to nevertheless access to the phishing source after being warned; and

(c.3) blocking the user from accessing the phishing source when the user chooses to escape from the phishing source.

Then, step (c.1) comprises the step (c.1.1) of re-directing the user to the warning webpage before accessing the phishing source for choosing between accessing to the phishing source and escaping from the phishing source.

An alternative to step (c.1.1) is the step (c.1.1′) of prompting a pop-up dialogue box before accessing the phishing source for choosing between accessing to the phishing source and escaping from the phishing source.

Moreover, step (c.3) comprises a sub-step (c.3.1) of re-directing the user to a predetermined website so as to block the user from accessing the phishing source.

Specifically in relation to emails, step (c) further comprises a step (c.4) of preventing users from receiving phishing emails to prevent them being deceived into accessing phishing websites.

In relation to phishing mails, the anti-phishing method further comprises a step (d) of sending the phishing email blacklist items to the relevant ISPs and other mail servers within the jurisdiction such that when a phishing email is sent to one of the ISP's users or other mail server users, the phishing email is prevented from being subsequently sent to the user. In other words, the possibility of widespread of the phishing emails can be minimized, and hopefully, eliminated at all.

From the forgoing descriptions, it can be shown that the above objects have been substantially achieved. The present invention provides an effective, jurisdictional-wide yet economical method of warning the users against phishing sources, thereby preventing them from being deceived too incur unnecessary loss.

To keep fully up-to-date about the blacklist phishing sources and their identifications, the anti-phishing method further comprises a step (e) of regularly updating the blacklist database so as to retain the latest information on any phishing sources on the internet.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An anti-phishing method, comprising the steps of:
(a) establishing an information center having a blacklist database comprising at least a phishing email blacklist and a phishing website blacklist, wherein said information center is liaising with at least one Internet service provider (ISP) through a communication network;
(b) collecting a plurality of phishing sources to be stored in said blacklist database to form a plurality of blacklist items selectively in said phishing email blacklist and said phishing website blacklist; and
(c) sending said blacklist items to said Internet service provider such that when a user of said Internet service provider tries to access a website source which matches with one of said blacklist items in said website database and said email database, said user receives a warning signal to inform said user that said website source is said phishing source.

2. The method as recited in claim 1, in step (b), further comprising the steps of:
(b.1) monitoring at least one data source to search for possible phishing sources having respective phishing identifications;
(b.2) preliminarily analyzing said possible phishing sources in said data source to identify said possible phishing source as suspected phishing source having said respective phishing identification; and
(b.3) verifying said suspected phishing source, and storing said corresponding phishing identifications as said blacklist items into said blacklist database when said suspected phishing sources are confirmed as phishing sources having said respective phishing identifications, wherein when said phishing source is a phishing website, said respective phishing identification is stored in said phishing website blacklist, wherein when said phishing source is a phishing email, said phishing identification is stored in said phishing email blacklist.

3. The method, as recited in claim 2, wherein said phishing sources are phishing emails having said respective phishing identifications embodied as respective phishing emails server's IP addresses, and phishing websites having said respective phishing identifications embodied as respective URLs of said phishing websites.

4. The method as recited in claim 3, in step (b.1), further comprising the steps of:
(b.1.1) sampling junk emails which are circulated on Internet; and
(b.1.2) receiving emails which are forwarded through said internet; and
(b.1.3) receiving user reports on said internet of said phishing sources having said respective phishing identifications.

5. The method as recited in claim 4, in step (b.2), further comprising the steps of:
(b.2.1) passing said reported phishing sources into a phishing analysis module; and
(b.2.2) screening said reported phishing sources for generating a list of suspected phishing websites.

6. The method as recited in claim 5, in step (b.3), further comprising the steps of:
(b.3.1) checking said suspected phishing sources one by one by an operator for confirming whether said suspected websites are indeed phishing websites; and
(b.3.2) storing said suspected phishing sources' identifications as said blacklist items when said operator confirms that said suspected phishing source is indeed said phishing source.

7. The method as recited in claim 6, in step (c), further comprising the sub-steps of:
(c.1) warning said user that said user is trying to enter a phishing website and prompting said user to choose between stopping entry and accessing to said phishing source;
(c.2) allowing said user to access to said phishing source when said user chooses to access said phishing source after being warned; and
(c.3) blocking said user from accessing said phishing source when said user chooses to escape from said phishing source.

8. The method as recited in claim 1, in step (c), wherein said warning signal is a warning webpage specifically linked with said information center and said internet service provider for allowing said user to choose between accessing said phishing source and escaping from said phishing source.

9. The method as recited in claim 7, in step (c), wherein said warning signal is a warning webpage specifically linked with said information center and said internet service provider for allowing said user to choose between accessing said phishing source and escaping from said phishing source.

10. The method as recited in claim 8, in step (c.1), further comprising a step of re-directing said user to a warning webpage before accessing said blacklist phishing source for choosing between accessing to said blacklist phishing source and escaping from said blacklist phishing source.

11. The method as recited in claim 9, in step (c.1), further comprising a step of re-directing said user to a warning webpage before accessing said blacklist phishing source for choosing between accessing to said blacklist phishing source and escaping from said blacklist phishing source.

12. The method as recited in claim 10, in step (b), further comprising a step (b.4) of saving phishing evidence into an evidence database of said information center for forming a basis for blocking access to phishing sources.

13. The method as recited in claim 11, in step (b), further comprising a step (b.4) of saving phishing evidence into an evidence database of said information center for forming a basis for blocking access to phishing sources.

14. The method, as recited in claim 12, further comprising a step (d) of sending said phishing email blacklist items to said ISP and email servers such that when a phishing email is sent to one of said ISP's users and said email servers' users, said phishing email is prevented from being subsequently sent to said user, so as to minimize a possibility of widespread of said phishing emails.

15. The method, as recited in claim 13, further comprising a step (d) of sending said phishing email blacklist items to said ISP and email servers such that when a phishing email is sent to one of said ISP's users and said email servers' users, said phishing email is prevented from being subsequently sent to said user, so as to minimize a possibility of widespread of said phishing emails.

16. The method, as recited in claim 14, further comprising a step (e) of regularly updating said blacklist database so as to retain latest information on any phishing sources on said internet.

17. The method, as recited in claim 15, further comprising a step (e) of regularly updating said blacklist database so as to retain latest information on any phishing sources on said internet.

18. The method, as recited in claim 16, wherein said phishing email blacklist stores IP addresses of phishing servers which originate phishing emails, and said phishing website blacklist stores ULRs of said phishing websites.

19. The method, as recited in claim 17, wherein said phishing email blacklist stores IP addresses of phishing servers which originate phishing emails, and said phishing website blacklist stores ULRs of said phishing websites.

20. The method as recited in claim 1, in step (c), wherein said warning signal is a warning pop-up dialogue box which temporarily freezes access to said phishing source until a response from said user is entered, wherein said warning pop-up dialogue box allows said user to choose between accessing said phishing source and escaping from said phishing source.

21. The method as recited in claim 7, in step (c), wherein said warning signal is a warning pop-up dialogue box which temporarily freezes access to said phishing source until a response from said user is entered, wherein said warning pop-up dialogue box allows said user to choose between accessing said phishing source and escaping from said phishing source.

22. The method as recited in claim 20, in step (c.1), further comprising a (c.1.1′) of prompting a pop-up dialogue box before accessing said blacklist phishing source for choosing between accessing to said blacklist phishing source and escaping from said blacklist phishing source.

23. The method as recited in claim 21, in step (c.1), further comprising a (c.1.1′) of prompting pop-up dialogue box before accessing said blacklist phishing source for choosing between accessing to said blacklist phishing source and escaping from said blacklist phishing source.

24. The method as recited in claim 22, in step (b), further comprising a step (b.4) of saving phishing evidence into an evidence database of said information center for forming a basis for blocking access to phishing sources.

25. The method, as recited in claim 23, wherein said step (b) further comprises a step (b.4) of saving phishing evidence into an evidence database of said information center for forming a basis for blocking access to phishing sources.

26. The method, as recited in claim 24, further comprising a step (e) of regularly updating said blacklist database so as to retain latest information on any phishing sources on said internet.

27. The method, as recited in claim 25, further comprising a step (e) of regularly updating said blacklist database so as to retain latest information on any phishing sources on said internet.

28. The method, as recited in claim 26, wherein said phishing email blacklist stores IP addresses of phishing servers which originate phishing emails, and said phishing website blacklist stores ULRs of said phishing websites.

29. The method, as recited in claim 27, wherein said phishing email blacklist stores IP addresses of phishing servers which originate phishing emails, and said phishing website blacklist stores ULRs of said phishing websites.
